(19) United States
(12) Patent Application Publication
(10) Pub. No.: US 2023/0385592 A1
(43) Pub. Date: Nov. 30, 2023

(54) RFID LABEL

(71) Applicant: ETIFIX GMBH, Grafenberg (DE)

(72) Inventors: Martin BOHN, Reutlingen (DE); Claus-Udo DUDZIK, Grafenberg (DE); Horst BRANZ, Metzingen (DE)

(21) Appl. No.: 18/044,726

(22) PCT Filed: Aug. 30, 2021
(86) PCT No.: PCT/EP2021/073911

§ 371 Date: Mar. 9, 2023

(30) Foreign Application Priority Data
Sep. 10, 2020 (DE) 10 2020 123 647.6
Dec. 23, 2020 (DE) 10 2020 134 854.1

(51) Int. Cl. G06K 19/077; B32B 38/04

(52) U.S. Cl. CPC G06K 19/07773; G06K 19/0776; B32B 38/04; B32B 2457/00; B32B 2038/042

(57) ABSTRACT

The invention relates to a method for producing an RFID label for use in particular on curved metal surfaces and on containers filled with liquids in the frequency range 860-960 MHz, having a substrate on which are arranged an electronic storage and transmission device designed as a microchip, a primary antenna galvanically connected to the microchip, and a secondary antenna coupled to the primary antenna, wherein the substrate is designed as a continuous strip in roll form which can be processed by machine with a plurality of secondary antennas arranged thereon, a first variant being characterized by the following steps: —punching the secondary antenna out of a conductive metallic layer, preferably a self-adhesive aluminum foil, and covering the secondary antenna with a preferably transparent self-adhesive film, in particular a polypropylene or polyethylene film; —punching a web out of a self-adhesive foam film; —applying the primary antenna to the covered secondary antenna at a position intended therefor and laminating a self-adhesive top material to a partial region of the upper side of the covered secondary antenna; and—applying an adhesive to a partial region of the upper side of the covered secondary antenna, laminating the unit consisting of the primary and secondary antennas to the self-adhesive foam film, and punching out the RFID label intended for subsequent folding.

The invention relates to an environmentally friendly, self-adhesive and flexible RFID label for application in particular on curved metal surfaces as well as on containers filled with liquids in the UHF (860-960 MHz) frequency range and a method for manufacturing the same. In the further description, this RFID label is referred to as an on-metal tag or OM tag.

Passive RFID labels usually consist of a printed or printable top material, an underlying inlay with chip and antenna on a PET substrate, and a suitable adhesive for adhesion to the surface of the object. Data is stored on the chip, e.g. a serial number, and captured via the antenna using an UHF reader. A metallic surrounding or liquids in the direct vicinity of the RFID label have a negative effect on the reading range of the RFID label due to detuning of the antenna, up to non-detection when sticking directly onto an electrically conductive surface or onto containers filled with liquids.

Various variants are already known for the production of RFID inlays for the UHF frequency range:

In a first variant, the antenna is mounted directly onto the substrate. This means that the antenna is already present as a one-piece component. The production can be done by etching or by printing or by punching. The chip is then placed at the designated location and conductively bonded, this is also called “bonding”. This method must be performed with very low tolerances. This naturally leads to determined machine requirements and also to higher costs. The antenna as a whole, even if it is designed as a single piece, is usually composed of a loop, which is a smaller antenna that is centrally located and that is connected or at least communicates by radio with a secondary antenna that is larger and ensures that the RFID label as a whole can be read from a greater range. In this first example, there is a galvanic connection between the loop and the secondary antenna; it is a one-piece component and then only the chip is provided as a second separate component.

In a second variant, a structure consisting of a loop or primary antenna and a secondary antenna is also used, which are also designed as a single piece, i.e. have a galvanic connection. The difference to the first example is that the chip is not applied directly to the loop, but to an intermediate component called a strap, or butterfly due to its design with two wing-like extensions. This strap is provided as a narrow strip or on a strip in large numbers one after the other and then the chip is again applied to the strap with very high precision. Then the strap is applied as a kind of sticker to the loop or primary antenna with a galvanic contact. For the function of the inlay, the accuracy of the positioning of the strap on the primary antenna plays a major role in this technique. On the cost side, this embodiment, approximately like the aforementioned first embodiment, is in the order of a few Euro cents per piece, depending on the design and size of the secondary antenna, with the number of pieces in the order of millions.

In a third variant, the UHF loop is produced first, i.e. the primary antenna. Then the chip is again placed with high precision at the determined position on the UHF loop. This is then a kind of intermediate component or intermediate product that can be kept ready in large quantities on a roll. Separately, the secondary antenna is then made, and the secondary antenna can again be made in different manners such as etching, punching, printing. The special feature here is that the UHF loop is not galvanically contacted with the secondary antenna during the joining process, but is coupled to the secondary antenna by electromagnetic coupling. A particular further feature of this third embodiment is that, due to the lack of galvanic connection between the UHF loop and the secondary antenna, it is possible to arrange the UHF loop at a distance from the secondary antenna. This means, for example, that the secondary antenna is located on one side of a sheet or piece of cardboard and the UHF loop on the other side, in such a manner that separation in the range of a few tenths of a millimeter to 1 mm to a maximum of even 10 mm is possible. In the two first-mentioned embodiments, such separation is not possible due to the galvanic connection. Due to the separate design or construction, the cost of this technique is somewhat higher than the first two variants. However, the modular design offers great advantages for design and manufacturing, such as the use of dual-frequency loops, with a chip that can be used in both the UHF range (860-960 MHz) and the HF range (13.56 MHz). In addition to the UHF loop, the chip is also connected to a RF antenna and can be sensed with UHF read/write apparatus or RF read/write apparatus, such as a NFC-enabled smartphone. The loop, referred to collectively as the UHF loop in the following, can therefore also be designed as a dual-frequency loop and is electromagnetically coupled to the secondary antenna in the UHF frequency band.

Various methods are known from the prior art for attaching and reading a RFID label on a metallic surface or on containers filled with liquids:
Create distance to metallic surface via air (Rigid OM tags), foam or absorber materials;
Design of the OM tag as a flag tag, i.e. the label stands out from the surface as a flag;
Integration of the antenna into the metallic object as a slot antenna;
Design and layout of the UHF antenna as a PIFA antenna (Planar Inverted F Antenna) with a metallic background to shield the background.

The starting point of the invention is the prior art flexible UHF on-metal tags with a direct contact etched aluminum UHF antenna on a PET carrier substrate, folded as a PIFA antenna and with an approximately 2 mm thick foam layer between the conductive surfaces of the antenna, with the following disadvantages:
The OM tags are not flexible. Due to the external conductive antenna surfaces, when the OM tags are attached to a curved surface, the internal stresses become so great that there are wrinkles in the OM tag and the restoring forces of the material cause the OM tag to detach or stand up over time.
The OM tags are unprinted after production and are preferably printed and encoded in a thermal transfer printer. The apparatus commonly available on the market can only print labels up to 0.3 mm thick; for 2 mm thick OM tags, the printers must be heavily modified. The printed image is usually not of high quality.
When coding the OM tags in the thermal transfer printer, care must be taken to ensure that the bottom part of the metallic OM antenna does not act as a shield and obstruct the coding.
The processes used to manufacture the antennas and the materials used are not environmentally friendly.
Due to the complex processes involved in production and further processing and the PET films used, OM tags are relatively expensive.

Based on this, the object of the invention is to provide an OM tag that is as environmentally friendly, cost-effective, thin and flexible as possible.

To solve this problem, the combinations of features indicated in the independent patent claims are proposed. Advantageous embodiments and developments of the invention result from the dependent claims.

In accordance with the invention, in a first embodiment, the manufacturing method comprises the following steps:
punching the secondary antenna from a conductive metal layer, preferably a self-adhesive aluminum film, and covering the secondary antenna with a preferably transparent self-adhesive film, in particular a polypropylene or polyethylene film;
punching a web from a self-adhesive foam film;
applying the primary antenna to the covered secondary antenna at a position provided therefor and laminating a self-adhesive top material to a portion of the upper side of the covered secondary antenna; and
applying an adhesive to a partial area of the upper side of the covered secondary antenna, laminating the unit of primary and secondary antennas to the self-adhesive foam film, and punching the OM tag intended for later folding.

In accordance with a second variation of the invention, the manufacturing method comprises the following steps:
punching the secondary antenna from a conductive metal layer, preferably a self-adhesive aluminum film, and covering the secondary antenna with a transparent self-adhesive film; in particular a polypropylene or polyethylene film;
punching a web from a self-adhesive foam film;
laminating a self-adhesive top material to a partial area of the upper side of the self-adhesive secondary antenna, and
applying an adhesive to a partial area of the upper side of the self-adhesive secondary antenna, laminating it to the self-adhesive foam film, and punching the UHF decoupler provided for later folding;
manufacturing of an UHF loop label; and
applying the UHF loop label to the UHF decoupler to form the RFID label intended for later folding.

In accordance with a third variation of the invention, the manufacturing method comprises the following steps:
producing an UHF inlay with chip as a one-piece component, wherein the UHF antenna is applied to a paper or film substrate by etching, printing or punching, and the UHF chip or UHF strap is bonded directly to the UHF antenna,
punching a web from a self-adhesive foam film,
laminating a self-adhesive top material to a partial area of the upper side of the UHF inlay and laminating a transfer film to the entire lower side of the UHF inlay, and
applying an adhesive to a partial area of the upper side of the self-adhesive UHF inlay, laminating it to the self-adhesive foam film, and punching the OM tag intended for later folding.

The OM tag according to the invention in accordance with the first manufacturing variant is characterized by a layered structure, by a siliconized carrier material with a first adhesive layer, a foam film layer with a centrally or eccentrically arranged groove as a later folding aid, a second adhesive layer, a secondary antenna, a third adhesive layer a foil layer, a fourth adhesive layer with which a primary antenna with a chip is adhered to the film layer, a fifth adhesive layer with which the printable top material is adhered to the film layer at least partially overlapping the primary antenna, and a sixth adhesive layer with which the OM tag is to be attached to a surface, wherein the sixth adhesive layer is covered with a siliconized carrier material.

The OM tag according to the invention in accordance with the second manufacturing variant is characterized by a siliconized carrier material, a first adhesive layer, a foam film layer with a centrally or eccentrically arranged groove as a subsequent folding aid, a second adhesive layer, a secondary antenna, a third adhesive layer, a film layer, a fourth adhesive layer, a layer of top material, a fifth adhesive layer with which the OM tag is to be attached to a surface, wherein the fifth adhesive layer is covered with a siliconized carrier material, and an UHF loop label.

The OM tag according to the invention in accordance with the third manufacturing variant is characterized by a siliconized carrier material, a first adhesive layer, a foam film layer with a centrally or eccentrically arranged groove as a subsequent folding aid, a second adhesive layer, an UHF inlay as a one-piece component, a third adhesive layer, a layer of top material, a fourth adhesive layer with which the OM tag is to be attached to a surface, wherein the fourth adhesive layer is covered with a siliconized carrier material.

The OM tag preferably consists of a small primary antenna with galvanically connected UHF chip, the UHF loop and a foldable secondary antenna, which in the folded state on the curved metal surface as a λ/4 emitter is responsible for appropriate range of the read or write function. The foldable secondary antenna with the foam as a gap or spacer acts as a decoupler from the metal surface similar to a PIFA antenna (Planar Inverted F-Antenna) and is further referred to as an OM antenna. The OM tag can only be used on metal surfaces when folded, because the necessary gap of approx. 2 mm between the antenna surfaces is then created. The UHF loop and the OM antenna are not galvanically connected. The coupling of the UHF loop and the OM antenna is designed via an electromagnetic field.

Providing the user with an OM tag that is still unfolded offers the advantage that the OM tag can be adhered to both flat and curved surfaces without causing major internal stresses in the composite material that would cause the material to warp and unintentionally detach the OM tag from its substrate. When adhering to flat surfaces, it is recommended to remove the label from its carrier film, fold the label into its final form and then adhere it to the surface. In the case of adhesion to a curved surface, on the other hand, it is advantageous if the label, after being removed from its carrier film, is first adhered to the curved surface with its adhesive area for the surface and only then is the folding performed. The portion of the siliconized carrier film that has covered the adhesive area for the surface can still be used as an anti-adhesion barrier to press the first wing of the OM tag before folding. The material layers are thus brought together without generating internal stresses.

In a further embodiment of the invention, two wings of the unfolded label formed by the groove have different lengths, in such a manner that when the label is glued onto a curved surface, the longer wing is folded over the shorter wing glued on first and covers the latter with a correspondingly larger radius of curvature without stress or warping, wherein, due to the greater length of the second wing, the free wing ends of the label terminate flush with one another.

The primary and secondary antennas are preferably printed or punched and are arranged on paper or a transparent film, preferably a PP or PE film made from recyclate. The OM tag is thus designed to be particularly sustainable or environmentally friendly.

Due to the preferred two-part design with UHF loop and OM antenna, different formats of OM antennas can be equipped with the same UHF loop. The UHF loop can be manufactured as a standard component in larger quantities. The OM antennas or decouplers can be manufactured on standard machines without special chip processing precautions. This results in particularly cost-effective production of the OM tags.

The self-adhesive top material laminated in production step 3 can also be processed as a printed and serialized top web with barcode, data matrix code or serial number. This eliminates the need for time-consuming printing and serialization in the thermal transfer printer later on. Here, the OM tags can be encoded contact-free via a barcode scanner and UHF write-read unit in a simple roll-to-roll process. As a pre-printed top web on a digital printing machine, the print quality is usually better than in a downstream thermal transfer printer or other label printer.

A further way of manufacturing the OM tags is to separately manufacture the UHF loops as a small UHF loop label with a printed, serialized and encoded chip and to apply it to the punched and not yet folded OM antenna with a label dispenser in a roll-to-roll process.

In the following, the invention is explained in more detail with reference to examples of embodiments shown schematically in the drawing. In the drawings:

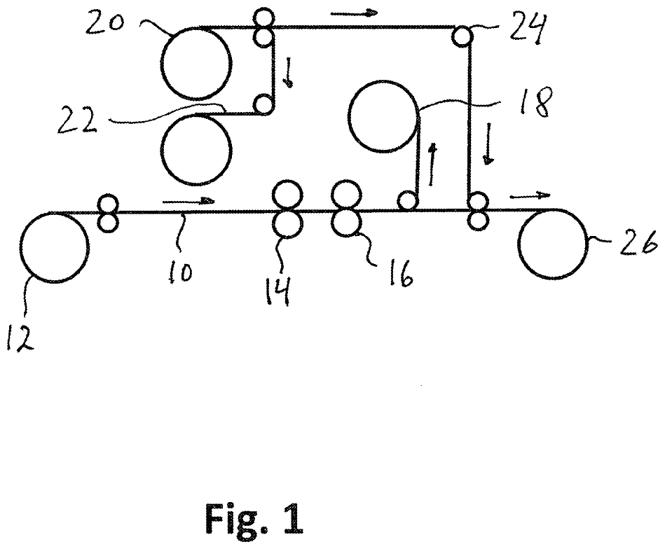

FIG. 1 shows a first manufacturing step for manufacturing the secondary antenna;

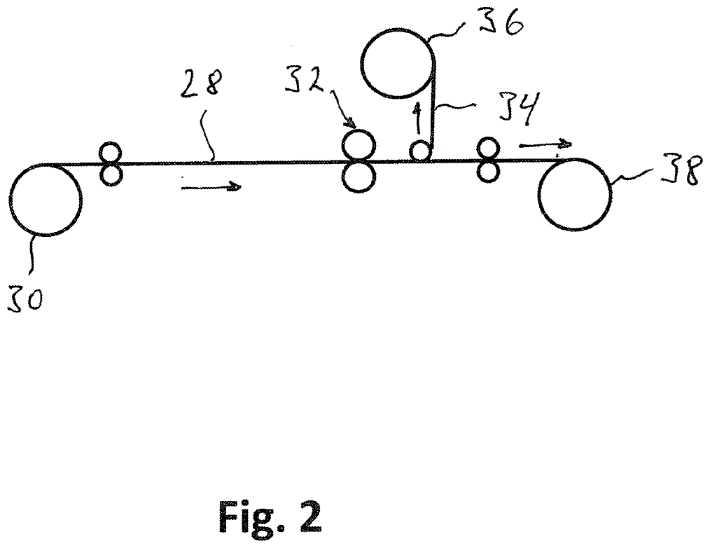

FIG. 2 shows a second manufacturing step for preparing a foam film as a subsequent substrate for the primary and secondary antennas;

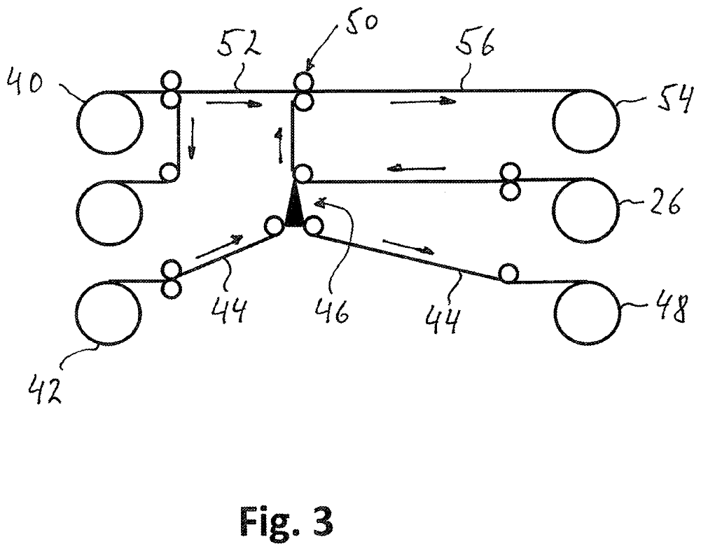

FIG. 3 shows a third manufacturing step in which the primary antenna is applied to the secondary antenna;

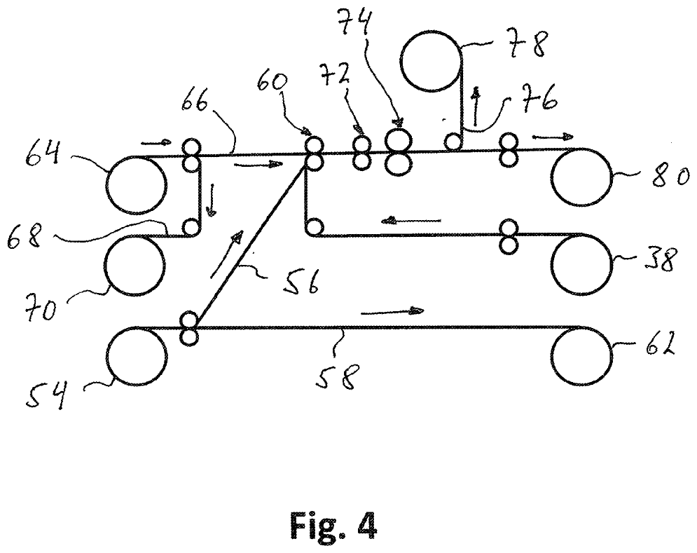

FIG. 4 shows a fourth manufacturing step in which the primary and secondary antennas are applied to the foam film substrate;

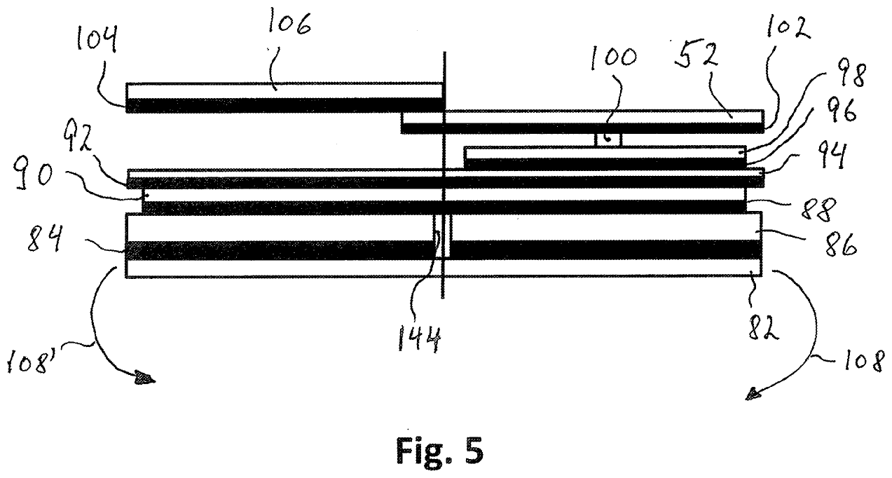

FIG. 5 shows a cross-section of a foldable OM tag;

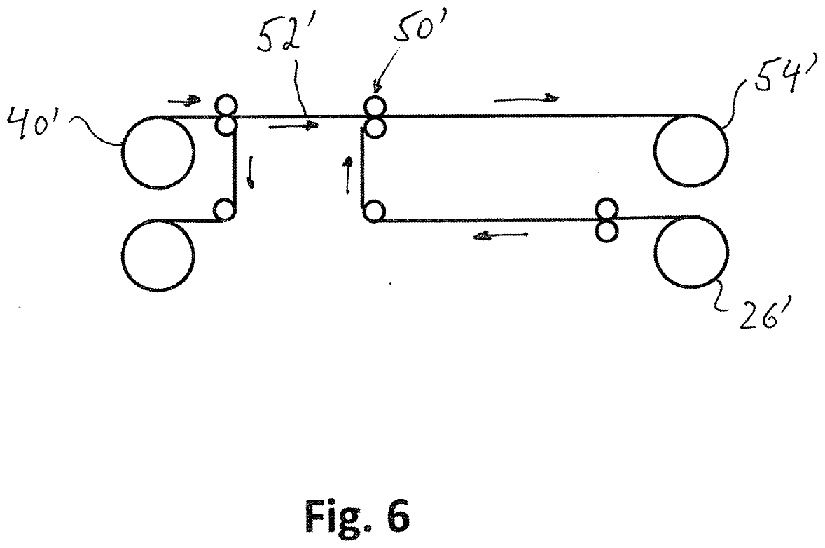

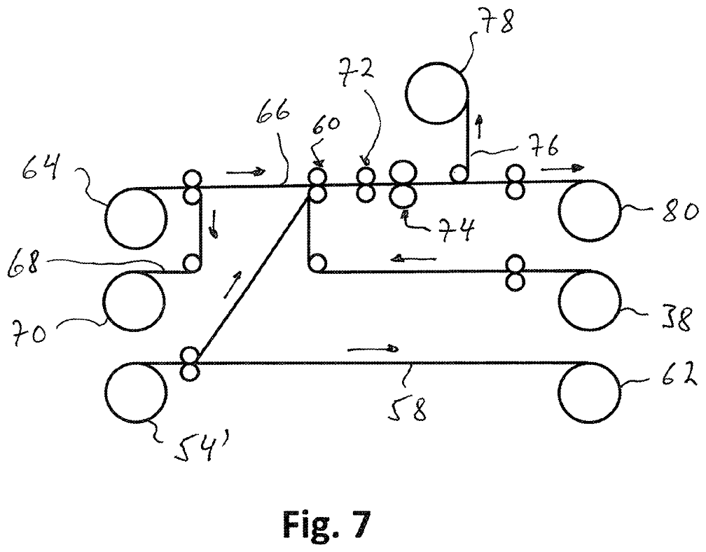

FIGS. 6 and 7 show alternative manufacturing steps to those shown in FIGS. 3 and 4;

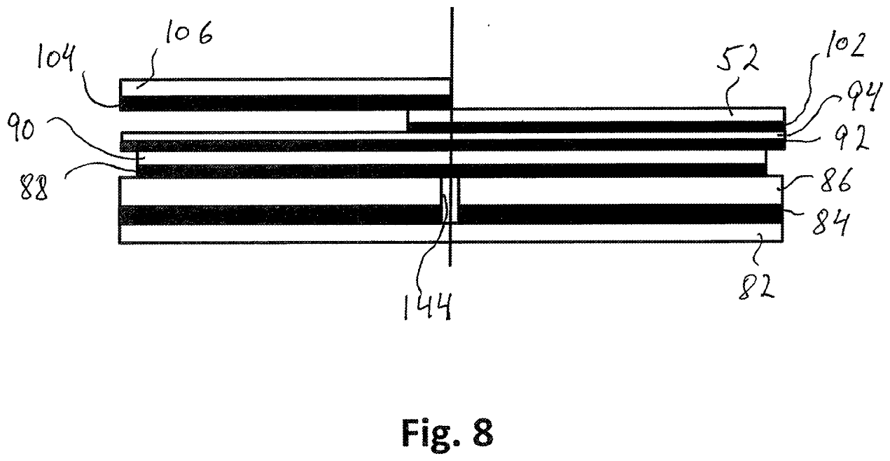

FIG. 8 shows a cross-section of an OM antenna manufactured using the steps shown in FIGS. 6 and 7;

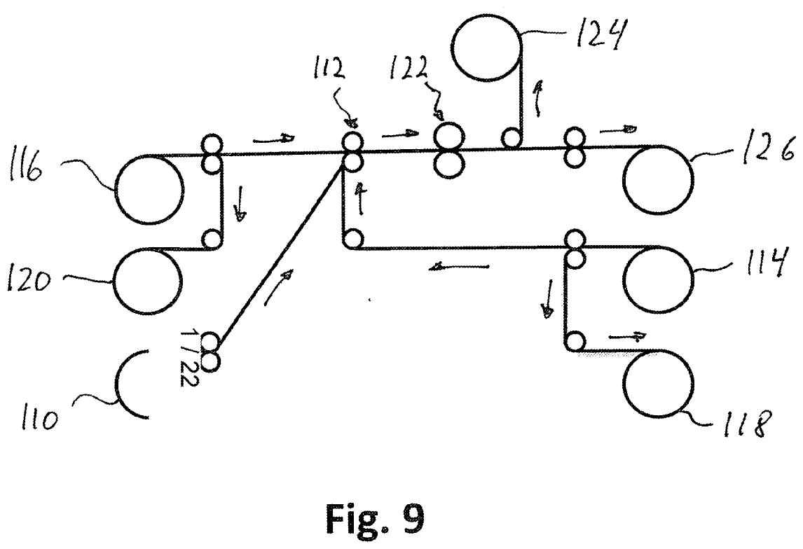

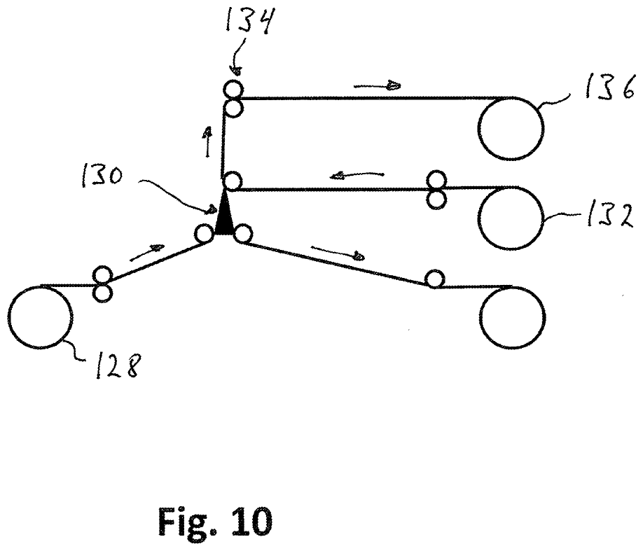

FIGS. 9 and 10 show manufacturing steps for fabricating an UHF loop label whose dispensing onto the OM antenna in accordance with FIG. 8 to form an OM tag;

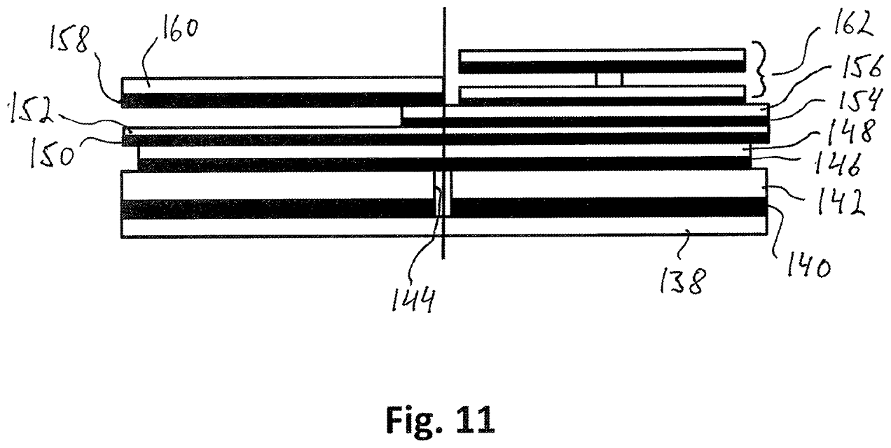

FIG. 11 shows a cross-section through the OM tag in accordance with FIG. 10;

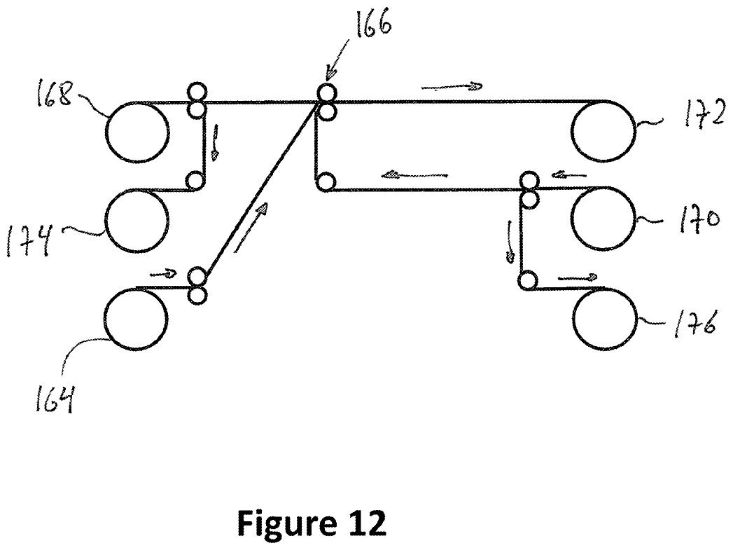

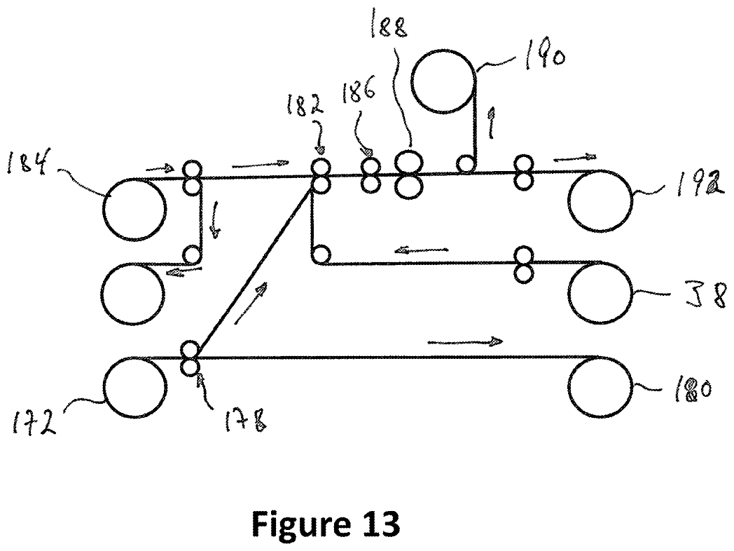

FIGS. 12 and 13 show alternative manufacturing steps to those shown in FIGS. 3 and 4;

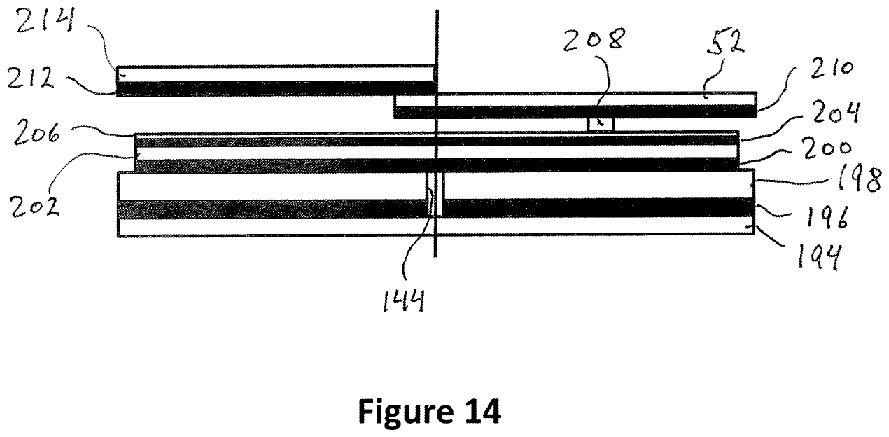

FIG. 14 shows a cross-section of a foldable OM tag produced using the steps depicted in FIGS. 12 and 13;

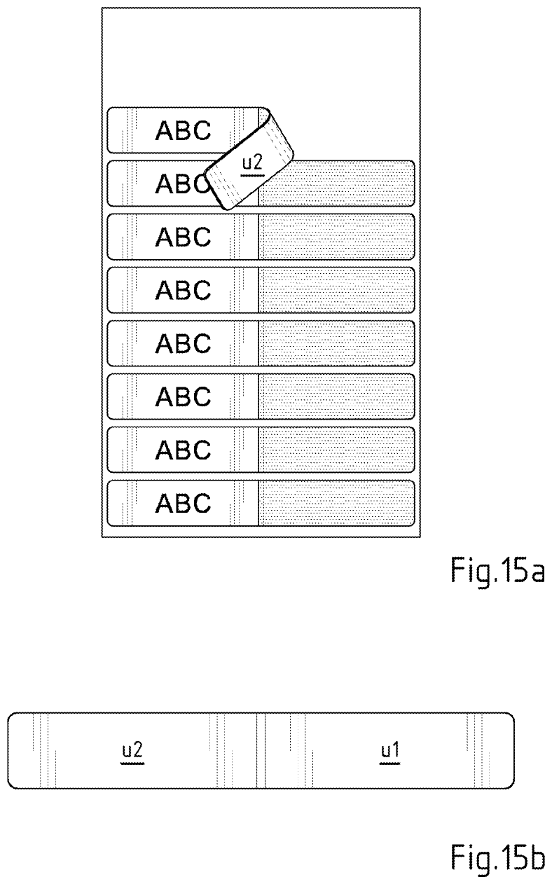

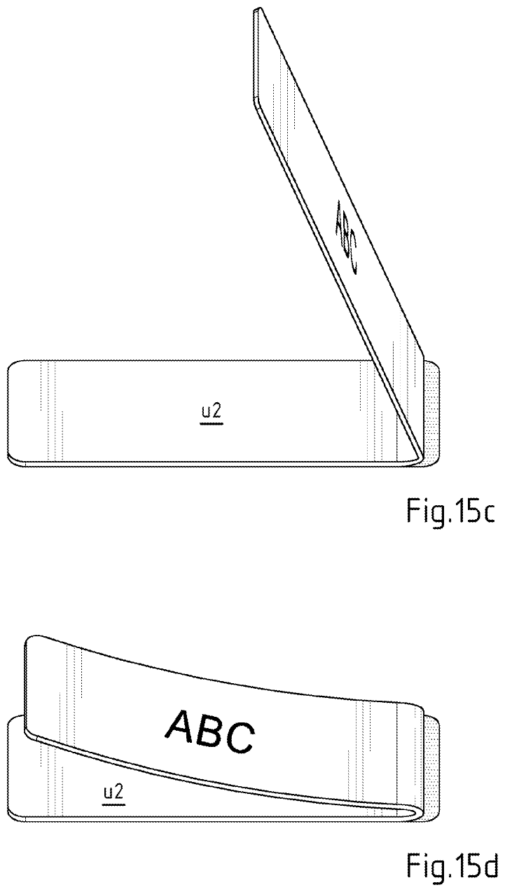

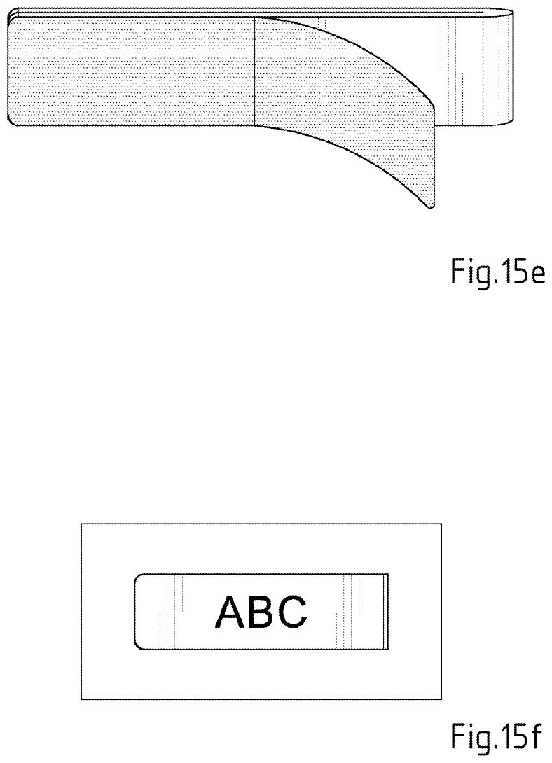

FIG. 15a to f show the procedure for adhering the OM tag to a flat surface; and

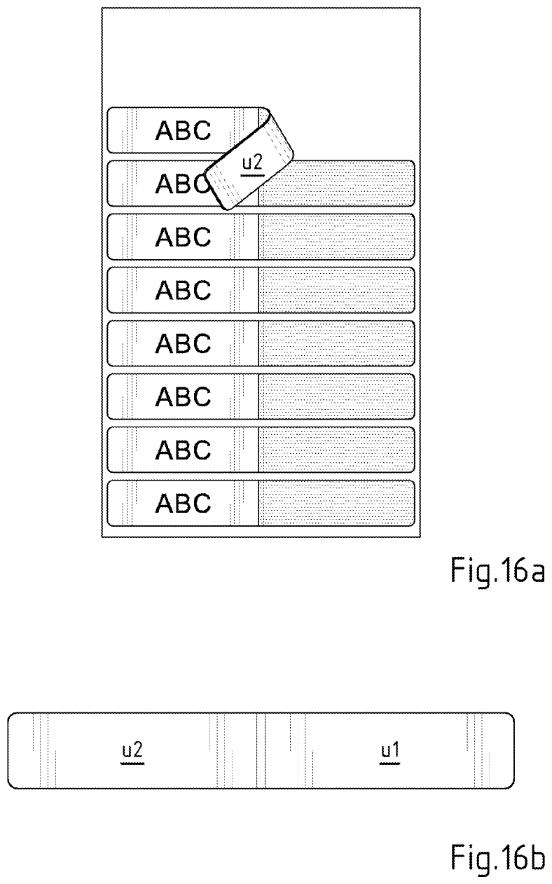

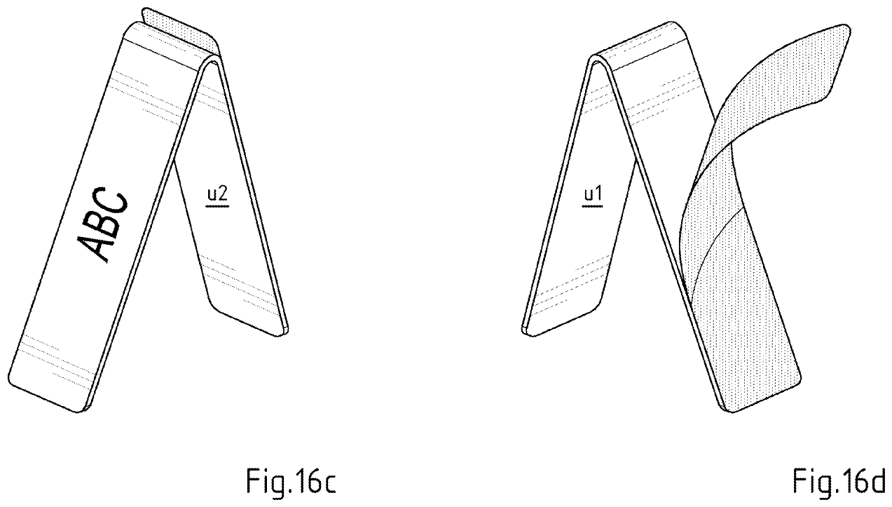

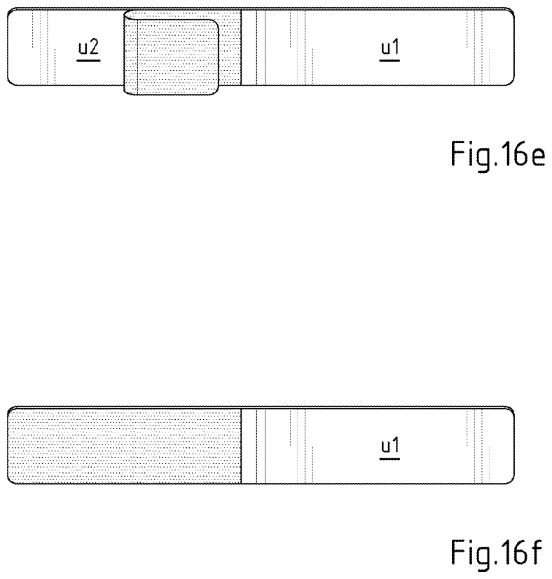

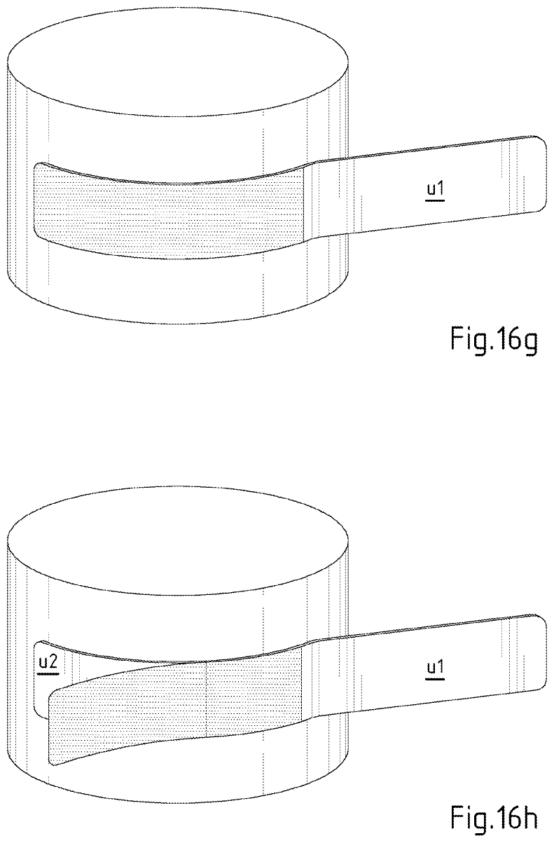

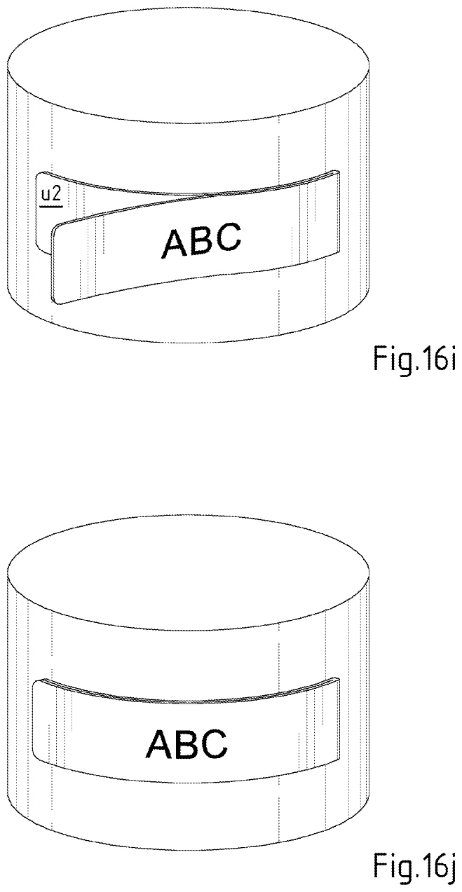

FIG. 16a to j show the procedure for bonding the OM tag to a cylindrically curved surface.

In the manufacturing step of an OM tag shown schematically in FIG. 1, which is particularly suitable for attachment to metallic objects, a self-adhesive aluminum film is first fed from a roll 12 to a printing station 14, in which a print mark is printed at regular distances on the film 10 as a subsequent reference mark in subsequent manufacturing steps. The secondary antenna is then shaped in a punching station 16. The punching grid is removed from the film 10 and rolled up on a roll 18. A self-adhesive film made of environmentally friendly material, preferably polypropylene or polyethylene material, is fed from another supply roll 20 and, after removal of its carrier substrate 22, is laminated to the upper side of the secondary antennas via a deflection roll 24. This first intermediate product is stored on a roll 26 for later processing.

In the manufacturing step shown in FIG. 2, a self-adhesive foam film 28 is prefabricated as a subsequent substrate for the antennas. For this purpose, the foam film 28 is fed from a dispenser roll 30 through a punching station 32, in which a web 34 is removed in the direction of travel of the foam film 28, which later creates a hinge function, as it were, for folding the end product of this manufacturing method. The punched web 34 is removed from the foam film 28 and rolled up on a roll 36. Two wide strips of the foam material, which typically has a thickness of about 0.5 mm to 2 mm, thus remain on the carrier material of the foam film 28. This intermediate product is stored on a roll 38 for later processing.

The first and second manufacturing steps can be performed independently of one another in terms of time and location and in any order.

In the manufacturing step shown in FIG. 3, the self-adhesive primary antenna is applied to the designated position of the secondary antenna and a printable or already printed top material is applied to one half, the later visible side of the OM tag, of the antenna composite. Three dispenser rolls are provided for this purpose: A roll 40 with the top material, a roll 42 on which the primary antennas are stocked, and the prepared roll 26 with the secondary antennas as an intermediate product from the first manufacturing step. A carrier film 44 with self-adhesive primary antennas arranged thereon is fed to a peeling device 46, to which the film with the secondary antennas is also fed, wherein peeled-off primary antennas are arranged at the position of the secondary antennas provided therefor. The carrier film 44 of the primary antennas is rolled up on a roll 48 as waste material. The composite of the primary and secondary antennas is provided with top material 52 dispensed from the roll 40 in a laminating station 50. The further intermediate product thus created is rolled up on a roll 54.

In the manufacturing step shown in FIG. 4, the intermediate products are combined in accordance with FIGS. 2 and 3. The intermediate product in accordance with FIG. 2, which is stocked on roll 38, serves as the base. The antenna composite 56 stored on the roll 54 is laminated onto this in a laminating station 60 after being pulled off its carrier material 58. The carrier material 58 is rolled up on a roll 62. In addition, in the laminating station 60, a transfer film 66 stocked on a roll 64 is applied to the side of the antenna composite 56 not provided with the printable top material 52 with an adhesive which is the subsequent adhesive layer for adhering the OM tag to its intended location. The carrier film 68 of the transfer film 66 is rolled onto a roll 70. After lamination, subsequent cutting and punching stations 72, 74 manufacture the final contours of the OM tag. The edge trim 76 or a punching grid is rolled up on a roll 78. If further processing is performed in a thermal transfer printer, the punching grid must not be removed completely in such a manner that the printer's print head can operate at a consistent level. The foldable OM tags are thus produced and rolled up on a roll 80. In this form, the OM tags can be delivered to the end user, who can print information on the top material 52 in a label printer.

FIG. 5 schematically shows the layered structure of the OM tag prior to removal from its siliconized carrier film 82 and folding into final form. The OM tag comprises a first adhesive layer 84, a foam film layer 86, a second adhesive layer 88, a secondary antenna 90, a third adhesive layer 92, a film layer 94, a fourth adhesive layer 96 with which a primary antenna 98 having a chip 100 is adhered to the film layer 94, a fifth adhesive layer 102 with which the printable top material 52 is adhered to the film layer at least partially overlapping the primary antenna, and a sixth adhesive layer 104 with which the OM tag is attached to its intended location. The adhesive layer 104 is initially still covered with a siliconized carrier film 106.

In accordance with a variant of the invention shown in FIGS. 6 to 11, the mechanically and electrostatically sensitive UHF loop with primary antenna and chip is arranged on the OM tag only at the end of its manufacture. The manufacturing steps shown in FIGS. 3 and 4 are modified as follows: As shown in FIG. 6, the third manufacturing step is modified in such a manner that no dispensing of the self-adhesive primary antennas or UHF loops is performed on the product from the first manufacturing step. In this step, only unwinding of the product from the first manufacturing step in accordance with FIG. 1 from a roll 26′ and lamination of the product with a top material 52′ dispensed from a roll 40′ takes place in a laminating station 50′. The product of this alternative third manufacturing step is rolled up on a roll 54′.

The subsequent alternative fourth manufacturing step in accordance with FIG. 7 corresponds fully to the manufacturing step shown in FIG. 4, wherein the product from the previous alternative third manufacturing step is now dispensed from the roll 54′. For further details of this alternative fourth manufacturing step, reference can be made to FIG. 4.

The product of the manufacturing step shown in FIG. 7 is shown in FIG. 8. Compared to the product shown in FIG. 5, the product in accordance with FIG. 8 comprises the secondary antenna 90, but not the primary antenna 98 with the chip 100. The product in accordance with FIG. 8 may be referred to as an UHF decoupler or OM antenna. By omitting the mechanically and electrostatically sensitive chip 100 and the self-adhesive primary antenna 98, this product can be manufactured on normal processing machines without special provisions for chip or inlay processing.

The UHF loop labels with primary antenna and chip for the UHF decoupler or OM antenna are manufactured in a further manufacturing step in accordance with FIG. 9. Dry UHF loops with chip are dispensed from a roll 110 without adhesive and fed to a laminating station 112. There, a transfer film from a roll 114 is fed from below and a self-adhesive, printed or printable top material from a roll 116 is fed from above. The carrier waste material of the transfer film and the top material is collected on rolls 118 and 120. The final form of the UHF loop labels is manufactured in a punching station 122. The punching grid is rolled up on a roll 124 and the UHF loop labels are stocked on a roll 126.

The UHF decouplers in accordance with FIG. 8 and the UHF loop labels produced in the method step in accordance with FIG. 9 are brought together in the method step shown in FIG. 10, which substantially corresponds to the method step in accordance with FIG. 3, wherein the top material already present no longer has to be laminated on, i.e. the roll 40 is no longer required. UHF loop labels are fed from a roll 128 to a peeling device 130 and applied to the UHF decoupler or OM antenna fed from a roll 132, passed through a laminating station 134, and collected as a finished product on a roll 136.

The finished product in accordance with FIG. 10 is shown in cross-section in FIG. 11. The OM tag in accordance with FIG. 11 comprises siliconized carrier film 138, a first adhesive layer 140, a foam film layer 142 having a groove 144 provided therein, a second adhesive layer 146, a secondary antenna 148, a third adhesive layer 150, a film layer 152, a fourth adhesive layer 154, a layer of top material 156, a fifth adhesive layer 158 for securing the OM tag to a surface, wherein the fifth adhesive layer 158 is covered with a siliconized carrier material 160, and the overall UHF loop label designated 162.

In the method variant shown in FIGS. 12 and 13, a punched, printed or etched UHF inlay is first (FIG. 12) unrolled from a roll 164 as a one-piece component and fed to a laminating station 166. There, a top material is fed from a roll 168 from the top and a transfer film having the width of the UHF inlay is fed from a roll 170 from the bottom. The product of this step is wound on a roll 172 for use in the subsequent method step. The siliconized carrier material of the top material or transfer film is rolled onto rolls 174 and 176.

The method step shown in FIG. 13 corresponds to that shown in FIG. 4. The laminated UHF inlay stocked on the roll 172 is separated from the siliconized carrier film in a preferential unit 178, which is collected as waste on a roll 180. In a laminating station 182, the UHF inlays are equipped from above with a transfer film from a roll 184 and from below with the foam film stocked on the roll 38 as a product of the method step shown in FIG. 2. After lamination, subsequent cutting and punching stations 186, 188 manufacture the final contours of the OM tag. The edge trim or a punching grid is rolled up on a roll 190. The foldable OM tags are thus produced and rolled up on a roll 192. In this form, the OM tags can be delivered to the end user, who can print information on the top material in a label printer.

FIG. 14 schematically shows the layered structure of the OM tag in accordance with FIGS. 12 and 13 prior to removal from its siliconized carrier film 194 and folding into its final form. The OM tag comprises a first adhesive layer 196, a foam film layer 198, a second adhesive layer 200, the UHF inlay consisting of a substrate 202 made of paper or plastic film, a third adhesive layer 204, an UHF antenna 206, and a chip 208, a fourth adhesive layer 210 with which the printable top material 52 is adhered to the film layer, and a fifth adhesive layer 212 with which the OM tag is attached to its intended location. The adhesive layer 212 is initially still covered with a siliconized carrier film 214.

For use, the OM tag in accordance with FIG. 5 (and correspondingly the OM tags in accordance with FIGS. 8, 11 and 14) is first removed from the siliconized carrier film 82 in a first application variant. This exposes the adhesive layer 84. The OM tag is now folded in the direction of the arrows 108, 108′, wherein it is helpful that the foam film layer 86 has in its central area a recess or groove 144 created in the second manufacturing step, which forms a hinge, as it were. The siliconized carrier film 106 is then removed to expose the sixth adhesive layer 104, which is used to attach the OM tag to its intended location. The printable top material 52 then faces away from the attachment location and is readable by the user. This application variant is recommended for attaching the OM tag to flat surfaces, as shown in FIG. 15: First (a) the OM tag is removed from the carrier. Then (b) the OM tag is rotated 180° around its longitudinal axis in such a manner that the surfaces marked u1 and u2 point upwards. Then (c, d) the OM tag is folded in such a manner that the surfaces u1 and u2 are glued together. Then (e) the silicone film is peeled off and (f) the OM tag is stuck onto the flat surface.

In a second application variant, which is recommended for curved surfaces, the OM tag is first removed from the siliconized carrier film 82, then the siliconized carrier film 106 is peeled off and the OM tag, which has not yet been folded, is attached to its intended location with the first wing. The portion of the siliconized carrier film 106 that has covered the adhesive area for the surface can still be used as an anti-stick barrier for pressing the first wing of the OM tag before folding the OM tag. Then, the free wing of the OM tag is folded in the direction of arrow 108. Since the wing glued on first has a slightly smaller radius of curvature than the initially still free wing after folding, the two halves of the foam film layer 86 are thus glued together without stress or warping. Expediently, the second wing is designed longer than the first wing due to the slightly larger radius in the folded state, in such a manner that the wing ends are flush with one another after folding. As FIG. 16 shows, first (a, b) the OM tag is again removed from the carrier and rotated. Then (c, d) the OM tag is folded, but not closed, and the silicone film is peeled off. The silicone film is placed (e, f) on the adhesive surface u2 as a handling aid and pressed on. Then (g) the first wing can be placed against the curved surface and, since the upper adhesive surface is covered by the silicone film, pressed on. The silicone film is again removed from the surface u2 (h) and the second wing is folded over the first and pressed on (i, j) without causing any stresses or distortions in the OM tag that has now been completely glued on.

The OM tag is easier for the user to process in its unfolded as-delivered state, especially with regard to roll handling, printing and coding in standard label printers. Furthermore, the modular design of the OM tag allows a wide range of materials and designs to be selected to meet specific requirements.

### LIST OF REFERENCE SIGNS

10 Aluminum film/film
12 Roll
14 Printing station
16 Punching station
18 Roll
20 Supply roll
22 Carrier substrate
24 Deflection roll
26, 26′ Roll
28 Foam film
30 Dispenser roll
32 Punching station
34 Web
36 Roll
38 Roll
40, 40′ Roll
42 Roll
44 Carrier film
46 Peeling device
48 Roll
50, 50′ Laminating station
52, 52′ Top material
54, 54′ Roll
56 Antenna composite
58 Carrier material
60 Laminating station
62 Roll
64 Roll
66 Transfer film
68 Carrier film
70 Roll
72 Cutting station
74 Punching station
76 Edge trim
78 Roll
80 Roll
82 Siliconized carrier film
84 First adhesive layer
86 Foam film layer
88 Second adhesive layer
90 Secondary antenna
92 Third adhesive layer
94 Film layer
96 Fourth adhesive layer
98 Primary antenna
100 Chip
102 Fifth adhesive layer
104 Sixth adhesive layer
106 Siliconized carrier film
108, 108′ Arrow
110 Roll
112 Laminating station
114 Roll
116 Roll
118 Roll
120 Roll
122 Punching station
124 Roll
126 Roll
128 Roll
130 Peeling device
132 Roll
134 Laminating station
136 Roll
138 Siliconized carrier film
140 First adhesive layer
142 Foam film layer
144 Groove
146 Second adhesive layer
148 Secondary antenna
150 Third adhesive layer
152 Film layer
154 Fourth adhesive layer
156 Top material
158 Fifth adhesive layer
160 Siliconized carrier material
162 UHF loop label
164 Roll
166 Laminating station
168 Roll
170 Roll
172 Roll
174 Roll
176 Roll
178 Preferential unit
180 Roll
182 Laminating station
184 Roll
186 Cutting station
188 Punching station
190 Roll
192 Roll
194 Siliconized carrier film
196 First adhesive layer
198 Foam film layer
200 Second adhesive layer
202 Substrate
204 Third adhesive layer
206 Antenna
208 Chip
210 Fourth adhesive layer
212 Fifth adhesive layer
214 Siliconized carrier film

1. A method for manufacturing a RFID label for the UHF frequency range, with a substrate on which an electronic storage and transmission device designed as a microchip, a primary antenna galvanically connected to the microchip, and a secondary antenna coupled to the primary antenna are arranged, wherein the substrate is designed as a machine-processable continuous strip in roll form with a plurality of secondary antennas arranged thereon, characterized by the following steps:
punching the secondary antenna from a conductive metal layer, preferably a self-adhesive aluminum film, and covering the secondary antenna with a transparent self-adhesive film;
punching a web from a self-adhesive foam film;
applying the primary antenna to the covered secondary antenna at a designated position and laminating a self-adhesive top material; and
applying an adhesive to a partial area of the upper side of the covered secondary antenna, laminating the unit of primary and secondary antennas to the self-adhesive foam film, and punching the RFID label intended for later folding.

2. The method for manufacturing a RFID label for the UHF frequency range, with a substrate on which an electronic storage and transmission device designed as a microchip, a primary antenna galvanically connected to the microchip, and a secondary antenna coupled to the primary antenna are arranged, wherein the substrate is designed as a machine-processable continuous strip in roll form with a plurality of secondary antennas arranged thereon, characterized by the following steps:
punching the secondary antenna from a conductive metal layer, preferably a self-adhesive aluminum film, and covering the secondary antenna with a transparent self-adhesive film;
punching a web from a self-adhesive foam film;
laminating a self-adhesive top material to a partial area of the upper side of the self-adhesive secondary antenna, and
applying an adhesive to a partial area of the upper side of the self-adhesive secondary antenna, laminating it to the self-adhesive foam film, and punching the UHF antenna provided for later folding;
manufacturing of an UHF loop label; and
applying the UHF loop label to the UHF antenna to form the RFID label intended for later folding.

3. The method for manufacturing a RFID label for the UHF frequency range, with a substrate on which an electronic storage and transmission device designed as a microchip and an UHF antenna galvanically connected to the microchip are arranged, wherein the substrate is designed as a machine-processable continuous strip in roll form with a plurality of UHF inlays arranged thereon, characterized by the following steps:
producing an UHF inlay with chip as a one-piece component, wherein the UHF antenna is applied to a paper or film substrate by etching, printing or stamping, and the UHF chip or UHF strap is connected directly to the UHF antenna in an electrically conductive manner,
punching a web from a self-adhesive foam film,
laminating a self-adhesive top material to a partial area of the upper side of the UHF inlay and laminating a transfer film to the entire lower side of the UHF inlay, and
applying an adhesive to a partial area of the upper side of the self-adhesive UHF inlay, laminating it to the self-adhesive foam film, and punching the RFID label intended for later folding.

4. The method according to any of claims 1 to 3, characterized in that by punching a web centrally or off-center from the self-adhesive foam film, a folding aid is created to facilitate folding of the RFID label prior to application or during application to its intended location.

5. The method according to any of claims 1 to 4, characterized in that the RFID label is not yet folded after punching and that the form fit with flat or curved metal surfaces or containers filled with liquid is created only during folding and application on flat surfaces or application and folding on curved surfaces.

6. A RFID label with UHF loop, characterized by a siliconized carrier film (82) as substrate, a first adhesive layer (84), a foam film layer (86), a second adhesive layer (88), a secondary antenna (90), a third adhesive layer (92), a film layer (94), a fourth adhesive layer (96) with which a primary antenna (98) with a chip (100) is adhered to the film layer (94), a fifth adhesive layer (102) with which the printable or printed top material (52) is adhered to the film layer in such a manner as to cover the primary antenna, and a sixth adhesive layer (104) with which the RFID label is fastened to its intended location, wherein the adhesive layer (104) is covered with a siliconized carrier film (106).

7. The RFID label with UHF loop label, characterized by a siliconized carrier film (138) as substrate, a first adhesive layer (140), a foam film layer (142) with a groove (144) provided, a second adhesive layer (146) a secondary antenna (148), a third adhesive layer (150), a film layer (152), a fourth adhesive layer (154), a layer of top material (156), a fifth adhesive layer (158) with which the RFID label is fastened to its intended location, wherein the adhesive layer (158) is covered with a siliconized carrier film (160), and an UHF loop label (162).

8. The RFID label with UHF inlay, characterized by a siliconized carrier film (194) as a substrate, a first adhesive layer (196), a foam film layer (198), a second adhesive layer (200), an UHF inlay as a one-piece component (202, 204, 206, 208) a third adhesive layer (210), a layer of top material (52), a fourth adhesive layer (212) with which the RFID label is fastened to its intended location, wherein the adhesive layer (212) is covered with a siliconized carrier film (214).

9. The RFID label according to any of claims 6 to 8, characterized in that two wings of the unfolded RFID label formed by the groove (144) have equal lengths for application to a flat surface and have different lengths for application to curved surfaces or over an edge.

10. A use of a RFID label according to any of claims 6 to 9, characterized in that the shorter wing is first adhered to a curved surface when the RFID label is adhered thereto, and then the longer wing is folded over the shorter wing and adhered to the shorter wing without tension or distortion, wherein the free wing ends of the label are flush with one another due to the greater length of the second wing.

11. The use of a RFID label according to any of claims 6 to 9, characterized in that when the RFID label is applied to a flat surface, the RFID label is removed from the siliconized carrier film (82, 138, 194) and folded through 180° with the aid of the groove (144), thereby bonding the two wings of equal length to one another without tension or warping, and then the siliconized carrier film (106, 160, 214) is pulled off and the RFID label is bonded to the flat surface at its intended location.

12. The use of a RFID label according to any of claims 6 to 9, characterized in that when the RFID label is applied to a curved surface or over an edge, the RFID label is removed from the siliconized carrier film (82, 138, 194) and pre-folded through 90° with the aid of the groove (144) in such a manner that the siliconized carrier film (106, 160, 214) is removable and serves as an operating aid or anti-adhesion barrier for pressing the shorter wing of the RFID label when adhered to the curved surface or over the edge at its intended location, and in that the operating aid or anti-adhesion barrier is removed again prior to folding and adhering the longer wing over the shorter wing.
